(19) United States
(12) Patent Application Publication
(10) Pub. No.: US 2019/0063600 A1
(43) Pub. Date: Feb. 28, 2019

(54) SHIFT ACTUATOR FOR CARRYING OUT A GEAR SELECTON OF A MANUAL TRANSMISSION FOR A VEHICLE, MANUAL TRANSMISSION SYSTEM FOR A VEHICLE, DRIVE TRAIN FOR A VEHICLE AND METHOD FOR INSTALLING A SHIFT ACTUATOR FOR A MANUAL TRANSMISSION OF A VEHICLE

(71) Applicant: ZF Friedrichshafen AG, Friedrichshafen (DE)

(72) Inventors: Joachim Spratte, Osnabrueck (DE); Wolfgang Fortmann, Bohmte (DE)

(73) Assignee: ZF Friedrichshafen AG, Friedrichshafen (DE)

(21) Appl. No.: 16/074,659

(22) PCT Filed: Jan. 9, 2017
(86) PCT No.: PCT/EP2017/050298

§ 371 Date: Aug. 1, 2018

(30) Foreign Application Priority Data
Feb. 12, 2016 (DE) 10 2016 202 188.5

(51) Int. Cl. F16H 61/32; F16H 59/04; F16H 1/28; F16H 61/22

(52) U.S. Cl. CPC F16H 61/32; F16H 59/044; F16H 2061/2892; F16H 1/28; F16H 61/22; F16H 59/041

(57) ABSTRACT

A shifter for gear selection in a gearshift transmission for a vehicle is or can be connected to an actuating unit for signal transmission to initiate a gear selection by means of a gear selection signal transmitted to the shifter. The shifter has at least one mechanical interface for mechanically coupling the shifter to the gearshift transmission by means of at least one connecting element. The shifter is configured to exert a translational movement on the at least one mechanical interface for executing the gear selection by means of the at least one connecting element as a function of the gear selection signal.

### BACKGROUND

The present invention relates to a shifter for gear selection in a gearshift transmission for a vehicle, a gearshift transmission system for a vehicle, a drive train for a vehicle, and a method for installing a shifter for a gearshift transmission in a vehicle.

Manual transmissions, automatic transmissions or automatic shifters, for example, are provided in many vehicles and vehicle platforms. Each of these concepts may require an individual operating concept, an individual shifting actuation, etc.

### SUMMARY

Based on this, the present invention creates an improved shifter for gear selection in a gearshift transmission for a vehicle, an improved shifting operation system for a vehicle, an improved drive train for a vehicle, and an improved method for installing a shifter in a vehicle according to the independent claims. Advantageous designs can be derived from the dependent claims and the following description.

An actuator close to the shifter for a gearshift transmission of a vehicle, in particular a manual transmission or an automated manual transmission can be created in accordance with embodiments of the present invention. The actuator for gear selection can be installed close to the shifter in both cases, on or in the central tunnel. In other words, a shifter for a gearshift transmission of a vehicle is or can be disposed at a distance to a transmission housing.

Installation space can be advantageously saved in the region of a transmission housing or gearshift transmission according to embodiments of the present invention. Furthermore, existing installation space in the region of a central tunnel or manual transmission can be exploited for gear selection in the gearshift transmission. By eliminating an actuator and control device incorporated in a transmission or transmission housing, not only can installation space be saved, particularly on the outside of the transmission, which is often limited, at least with large motors and transmissions, but the electronics and actuators can also be configured with less vibration resistance and sealing than when installed directly on the transmission.

A uniform installation space may be reserved in a vehicle for an actuating unit or control unit for automatic, automated gearshift transmissions and gearboxes in the passenger compartment under the maximum requirements, and a central console can be designed in a modular manner in particular, if there is a central console. By way of example, according to embodiments of the present invention, it is possible to implement more transmission options with a uniform shift-by-wire transmission that can support all of the existing concepts and may be adaptable, with the same installation space and same interior design, wherein an operating concept can be similar or identical in each vehicle. In particular, installation space requirements for the functionality of an automated gearshift transmission can be reduced. Furthermore, modules developed according to lower specifications, for example, such as a shifter, can be used or implemented. In particular, by integrating a control device in the shifter, or actuator unit, a control device, disposed for example on the transmission housing, can also be eliminated. An at least partially autonomous driving operation can be enabled for manual transmissions, for example, according to embodiments of the present invention.

A shifter for gear selection in a gearshift transmission of a vehicle can exchange signals with an actuating unit for initiating a gear selection by means of a gear selection signal transmitted to the shifter can be or is connected thereto, wherein the shifter has at least one mechanical interface for mechanically coupling the shifter to the gearshift transmission by means of at least one connecting element, wherein the shifter is configured to exert a displacement or translational movement on the at least one mechanical interface for the gear selection by means of the at least one connecting element as a function of the gear selection signal.

The vehicle can be a motor vehicle, in particular a road vehicle, e.g. a passenger car, a truck, or another type of utility vehicle. The gearshift transmission can be configured as a manual transmission as well as, additionally or alternatively, an automated manual transmission. A gear or gear step can be selected in the gearshift transmission during gear selection, and additionally or alternatively be implemented. The shifter can be or is connected to the control unit by means of an electrical line, for example. The control unit can be configured to detect a shifting by a driver of the vehicle. The control unit can be configured to provide the gear selection signal in response to a shifting by a driver of the vehicle, and additionally or alternatively in response to a control signal. The at least one connecting element can be a cable pull or a rod. A displacement or translational movement can be understood to be a linear movement of an element or part of the mechanical interface.

According to one embodiment, the shifter can have a drive unit and a planetary gear assembly. The planetary gear assembly can be coupled to the drive unit at the input end. At the output end, the planetary gear assembly can be coupled to the at least one mechanical interface. Such an embodiment offers the advantage that the transmission can consume less space.

The shifter can also have a worm gear, which can be coupled to the drive unit at the input end, and to the planetary gear assembly at the output end. The drive unit can be an electric motor. Such an embodiment offers the advantage of a gear reduction in a simple and reliable manner.

In particular, the planetary gear assembly can include a sun gear at the input end, and at least one planet gear at the output end, which can be disposed on a carrier, and one ring gear. The shifter can have a switching unit, which can be configured to lock the carrier or the ring gear in place as a function of the gear selection signal. The at least one planet gear can be engaged between the sun gear and the ring gear. In particular, the planetary gear assembly can have at least two planet gears, which can be disposed on the carrier. Such an embodiment offers the advantage that a safe-saving planetary gear assembly can be created in which stationary shafts and rotating axles extend parallel to one another within production tolerances.

The shifting unit can include at least one electromagnet and a snap-fit rocker, which can be moved by the electromagnet. The carrier can have a first snap-fit section, and the ring gear can have a second snap-fit section. The snap-fit rocker can be configured here to snap in place in the first snap-fit section or the second snap-fit section. A snap-fit section can be a snap-fit toothing. The electromagnet can be configured to move the snap-fit rocker independently of the gear selection signal. Such an embodiment offers the advantage that it is possible to switch between two output drives in a simple and reliable manner.

The shifter can also have a first mechanical interface for mechanically coupling the shifter to the gearshift transmission by means of a first connecting element and a second mechanical interface for mechanically coupling the shifter to the gearshift transmission by means of a second connecting element. In both cases, the first mechanical interface can be coupled to the ring gear of the planetary gear assembly, and the second mechanical interface can be coupled to the carrier. Such an embodiment offers the advantage that gear selection can be facilitated in the gearshift transmission by means of two connecting elements.

According to one embodiment, the at least one mechanical interface can comprise an eccentric and a slider, which can be mechanically coupled to one another. By rotating the eccentric, the slider is moved in a translational manner. The slider can be designed to be coupled mechanically to a connecting element. Such an embodiment offers the advantage that a rotational movement can be translated into a linear movement in a simple and space-saving manner.

Furthermore, the shifter can comprise at least one sensor, which can be configured to detect a position, and additionally or alternatively, a pathway of the at least one mechanical interface. Such an embodiment offers the advantage that an execution or implementation of a gear selection can be securely controlled.

A gearshift transmission system for a vehicle has the following features: an embodiment of the aforementioned shifter; an actuating unit for initiating a gear selection by means of the gear selection signal transmitted to the shifter, wherein the actuating unit can be or is connected to the shifter for signal transmission, wherein the actuating unit has a control device for providing the gear selection signal; a gearshift transmission; and at least one connecting element, by means of which the gearshift transmission and the shifter can be or are mechanically coupled to one another.

An embodiment of the aforementioned shifter can be advantageously implemented or used in conjunction with the gearshift transmission system, in order to make a gear selection in a gearshift transmission.

According to one embodiment, when the gearshift transmission system has been installed, the shifter can be disposed in the vehicle closer to the actuating unit than the gearshift transmission. In other words, an installation position of the shifter can be closer to the actuating unit than the gearshift transmission. Such an embodiment offers the advantage that installation space can be saved in the region of the gearshift transmission, and the shifter can be less complex.

The at least one connecting element can also be exposed between the housing of the gearshift transmission and the shifter when the gearshift transmission system is installed in the vehicle. Such an embodiment offers the advantage that there can be a greater distance between the gearshift transmission and the shifter than between the shifter and the actuating unit. As a result, existing installation space can be put to better use and less installation space is needed on the gearshift transmission.

A drive train for a vehicle has the following features: an embodiment of the aforementioned gearshift transmission system; a motor; a clutch, which can be or is mechanically interconnected between the motor and the gearshift transmission system; and a clutch actuator for actuating the clutch, wherein the clutch actuator can be or is mechanically coupled to the clutch, wherein the clutch actuator can be or is connected to the actuating unit of the gearshift transmission system for signal transmission therewith.

An embodiment of the aforementioned gearshift transmission system can be advantageously implemented or used in conjunction with the drive train in order to implement an automated manual transmission, for example.

According to one embodiment, the clutch actuator can be or is disposed adjacent to the clutch. Such an embodiment offers the advantage that in particular with an automatic transmission, installation space can be saved in the region of the clutch.

According to another embodiment, the clutch actuator can be or is disposed adjacent to a set of pedals in the vehicle. The clutch actuator can be or is mechanically coupled to the clutch via a further connecting element. The further connecting element can be in the form of a pull cable. Such an embodiment offers the advantage that installation space can be saved in the region of the clutch, in particular with a manual transmission.

A method for installing a shifter for a gearshift transmission in a vehicle comprises a step for placing the shifter of an embodiment of the aforementioned gearshift transmission system closer to the actuating unit than the gearshift transmission.

The installation method can be executed in conjunction with or using an embodiment of the aforementioned shifter and an embodiment of the aforementioned gearshift transmission system. At least some of the components of the gearshift transmission system can be pre-installed thereby. The method can also comprise a step for mechanically coupling the shifter to the gearshift transmission by means of the at least one connecting element. The method can also comprise a step for connecting the shifter to the actuating unit for signal transmission.

### BRIEF DESCRIPTION OF THE DRAWINGS

The invention shall be explained in greater detail based on the attached drawings. Therein:

FIG. 1 shows a schematic illustration of a drive train according to an exemplary embodiment of the present invention;

FIG. 2 shows a schematic illustration of a drive train according to an exemplary embodiment of the present invention;

FIG. 3 shows a schematic illustration of a shifter according to an exemplary embodiment of the present invention;

FIG. 4 shows a schematic illustration of a portion of the shifter from FIG. 3;

FIG. 5 shows a schematic illustration of a portion of the shifter from FIG. 4;

FIG. 6 shows a schematic illustration of a shifting pattern according to an exemplary embodiment of the present invention; and

FIG. 7 shows a flow chart for an installation method according to an exemplary embodiment of the present invention.

### DETAILED DESCRIPTION

Before describing exemplary embodiments of the present invention below, the fundamentals of conventional gearshift transmissions shall be explained. With manual transmissions, gears are normally selected and engaged, for example, via two cable pulls. An actuation of a clutch takes place with a pedal via a rod or a cable pull. Automated manual transmissions are implemented, for example, such that an actuator packet is placed on a transmission. This actuator packet actuates the vehicle clutch, and also selects the gears. The gear selection normally takes place via two rotational movements, wherein one rotational movement selects the gear, and the other engages the gear. The actuators are normally disposed on the exterior of the transmission, for example. The actuators are normally activated by a control device installed close to the actuator.

In the following description of preferred exemplary embodiments of the present invention, identical or similar reference symbols shall be used for elements having a similar function in the various figures, wherein there shall be no repeated descriptions of these elements.

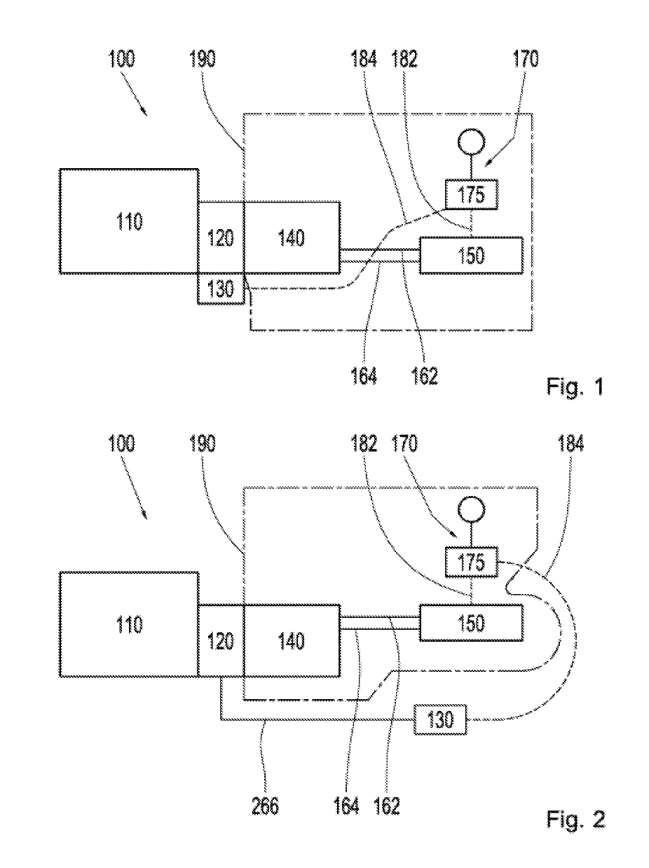

FIG. 1 shows a schematic illustration of a drive train 100 according to an exemplary embodiment of the present invention. The drive train 100 is intended for a vehicle. In other words, the drive train 100 is intended or configured for use in a vehicle. The vehicle is a motor vehicle.

Comprising the drive train 100, a motor 110, a clutch 120, a clutch actuator 130, a gearshift transmission 140, a shifter 150, a first connecting element 162 and second connecting element 164, shown merely by way of example, an actuating element 170 with a control device 175, and a first electrical interface 182 and second electrical interface 184 are shown in the illustration in FIG. 1. The gearshift transmission 140, the shifter 150, the connecting elements 162 and 164, the actuating unit 170 with the control device 175, and the merely exemplary electrical interface 182 represent a gearshift transmission system therein.

The motor 110 is an internal combustion engine in the exemplary embodiment of the present invention shown in FIG. 1. The clutch 120 is disposed adjacent to the motor 110. The clutch 120 is mechanically coupled to the motor 110. Furthermore, the clutch 120 is mechanically interconnected between the motor 110 and the gearshift transmission system 190 herein. More precisely, the clutch 120 is mechanically interconnected between the motor 110 and the gearshift transmission 140.

The clutch actuator 130 is disposed adjacent to or adjoining the clutch 120 according to the exemplary embodiment of the present invention shown in FIG. 1. The clutch actuator 130 is mechanically coupled to the clutch 120. The clutch actuator 130 is configured for actuating the clutch 120. Furthermore, the clutch actuator 130 is connected to the control device 175 of the actuating unit 170 by means of the second electrical interface 185, configured as an electrical line, for example.

The gearshift transmission system 190 is configured as an automated manual transmission. The gearshift transmission 140 is mechanically coupled to the shifter 150 by means of the connecting elements 162 and 164. The connecting elements 162 and 164 take the form of cable pulls according to the exemplary embodiment of the present invention shown in FIG. 1. According to one exemplary embodiment, the connecting elements 162 and 164 are exposed between the gearshift transmission 140 or a housing for the gearshift transmission 140 and the shifter 150.

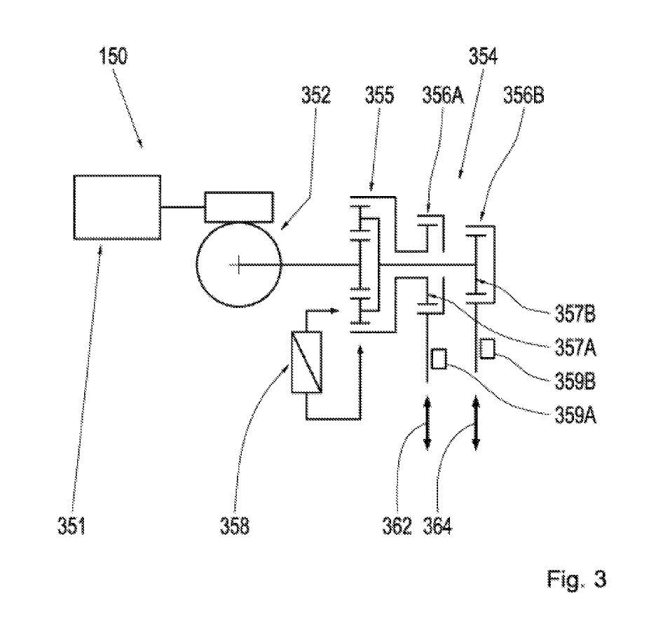

The shifter 150 is connected to the actuating unit 170 for signal transmission by means of the first electrical interface 182, more precisely to the control device 175 of the actuating unit 170. The shifter 150 is configured for executing a gear selection in the gearshift transmission 140, made via the actuating unit 170, by means of the connecting elements 162 and 164. The shifter 150 is configured for receiving or inputting a gear selection signal from the actuating unit 170 via the electrical interface 182. The shifter 150 is disposed closer to the actuating unit 170 than to the gearshift transmission 140. In other words, each of the connecting elements 162 and 164 are longer than the first electrical interface 182. The shifter 150 shall be described in greater detail below, in particular with reference to FIGS. 3 to 5.

The actuating unit 170 comprises the control device 175. The actuating unit 170 also comprises a gearshift lever or suchlike, for example, serving as a user interface. The actuating unit 170 is configured for initiating the gear selection by means of the gear selection signal transmitted to the shifter 150 via the first electrical interface 182. The control device 175 in the actuating unit 170 is configured to provide the gear selection signal.

FIG. 2 shows a schematic illustration of a drive train 100 according to an exemplary embodiment of the present invention. The drive train 100 shown in FIG. 2 corresponds to the drive train depicted in FIG. 1, with the exception that the clutch actuator 130 is disposed adjacent to a pedal system in the vehicle, or at a distance to the clutch 120. The clutch actuator 130 is mechanically coupled to the clutch 120 thereby via a further connecting element 266. The further connecting element 166 is in the form of a cable pull.

In reference to FIGS. 1 and 2, it should be noted with regard to the operation of a drive train 100, that gears can be selected via the two connecting elements 162 and 164, or the two cable pulls 162 and 164, in a manner similar to that with a manual transmission. The clutch 120 is actuated by the clutch actuator 130, which is disposed on the clutch 120, on the gearshift transmission 140, or in the region of the pedals in the vehicle. The clutch actuator 130 can thus be placed in either the region of the clutch 120 or in the region of the pedals. The functionality of a control device is assumed by the shifter actuation, or the control device 175 in the actuating unit 170, respectively. The installation space used for this application is the installation space that would be used in other transmissions for shifting a manual transmission.

FIG. 3 shows a schematic illustration of a shifter 150 according to an exemplary embodiment of the present invention. The shifter 150 is the shifter 150 from FIG. 1 or FIG. 2, or a similar shifter. The shifter 150 is configured for gear selection in a gearshift transmission for a vehicle. The shifter 150 can be implemented or used here in conjunction with the gearshift transmission system from FIG. 1 or FIG. 2, or a similar gearshift transmission system.

FIG. 3 shows that the shifter 150 comprises a drive unit 151, e.g. in the form of an electric motor, a worm gear 352, a planetary gear 354, two mechanical interfaces 356A, 356B, 357A, and 357B, merely by way of example, a switching unit 358, and two sensors 359A and 359B, merely by way of example.

More precisely, a planet gear set 355, a first slider 356A, a second slider 356B, a first eccentric 357A and a second eccentric 357B of the planetary gear assembly 354 are shown. The first slider 356A, the second slider 356B, the first eccentric 357A and the second eccentric 357B represent the mechanical interfaces thereby according to the exemplary embodiment of the present invention shown in FIG. 3. According to the exemplary embodiment of the present invention shown in FIG. 3, the mechanical interfaces 356A, 356B, 357A and 357B are components of the planetary gear assembly 354. The switching unit 358, a first sensor 359A and a second sensor 359B are dedicated to the planetary gear assembly 354, or disposed adjacent to the planetary gear assembly 354.

The planetary gear assembly 354 is coupled to the drive unit 351 at the input end. According to the exemplary embodiment of the present invention shown in FIG. 3, the planetary gear assembly 354 is coupled to the drive unit 351 via the worm gear 352. The worm gear 352 is thus coupled to the drive unit 351 at the input end and to the planetary gear assembly 354 at the output. The worm gear 352 is configured for pre-downshifting.

The planetary gear assembly 354 is coupled to the mechanical interfaces 356A, 356B, 357A and 357B at the output end. In other words, the planetary gear assembly 354 has the planetary gear set 355 at the input end and the planetary gear assembly 354 has the mechanical interfaces 356A, 356B, 357A, and 357B at the output end.

The mechanical interfaces 356A, 356B, 357A, and 357B of the shifter 150 are configured to mechanically couple the shifter 150 to the gearshift transmission of the gearshift transmission system by means of connecting elements. The shifter 150 is configured thereby to exert a translational movement on the mechanical interfaces 356A, 356B, 357A, and 357B, as a function of the gear selection signal from the actuating unit, by means of the connecting elements in order to execute a gear selection. In other words, the shifter 150 is configured to exert a translational movement on the connecting elements, as a function of the gear selection signal, by means of the mechanical interfaces 356A, 356B, 357A, and 357B.

For this, the first eccentric 357A is mechanically coupled to the first slider 356A, and the second eccentric 357B is mechanically coupled to the second slider 356B. The first slider 356A is formed such that it is or can be mechanically coupled to the first connecting element. The second slider 356B is formed such that it is or can be mechanically coupled to the second connecting element. A rotation of the first eccentric 357A causes a displacement of the first slider 356A. A rotation of the second eccentric 357B causes a displacement of the second slider 356B. Moreover, a first movement axis 362 of the first slider 356A and a second movement axis of the second slider 356B are shown in FIG. 3.

The switching unit 358 is connected to the actuating unit for signal transmission. The switching unit 358 is configured to input or receive the gear selection signal from the actuating unit. The switching unit 358 is configured to activate the first mechanical interfaces 356A and 357A or the second mechanical interfaces 356B and 357B as the output from the planetary gear assembly 354.

The first sensor 359A is dedicated to the first mechanical interfaces 356A and 357A, and the second sensor 359B is dedicated to the second mechanical interfaces 356B and 357B. The first sensor 359A is configured to detect the position and/or a pathway of the first slider 356A, wherein the second sensor 359B is configured to detect the a position and/or pathway of the second slider 356B.

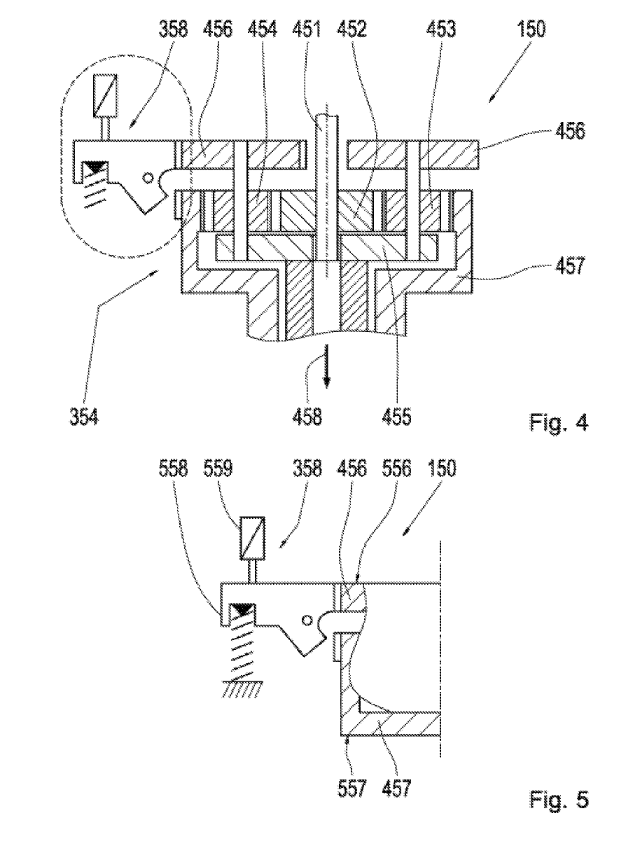

The planetary gear assembly 354, and in particular the switching unit 358 shall be explained in greater detail below with reference to the FIG. 4 and FIG. 5.

FIG. 4 shows a schematic illustration of a portion of the shifter 150 from FIG. 3. In particular, the planetary gear assembly 354 and the switching unit 358 of the shifter 150 are shown therein.

The planetary gear assembly 354 has a drive shaft 451, which is coupled to a sun gear 452. The sun gear 452 engages with a first planet gear 453 and a second planet gear 454, shown merely by way of example for purposes of illustration. The planet gears 453 and 454 are mounted on a planet carrier or planet gear carrier 455. The planet gear carrier 455 also has an extended section 456. The planet gear carrier 455 and the extended section 456 are rigidly coupled to one another thereby. The planet gears 451 and 454 engage with a ring gear 457. The extended section 456 of the planet gear carrier 455 extends from a region encompassed by the ring gear 457. The planet gears 451 and 454 are disposed between the sun gear 452 and the ring gear 457. An output 458 of the planetary gear assembly 354 takes place selectively via the planet gear carrier 455 or the ring gear 4557. The planet gear carrier 455 and the ring gear 457 can be coupled to the mechanical interfaces of the shifter 150 or the planetary gear assembly 354, or could be coupled to the mechanical interfaces.

The switching unit 358 is disposed adjacent to a region of the extended section 456 of the planet gear carrier 455 and to a region of the ring gear 457. The switching unit 358 shall be explained in greater detail below with reference to FIG. 5. A section or excerpt of the shifter 150 is also symbolically circled in FIG. 4, which is enlarged in FIG. 5. The circled section comprises, in particular, the switching unit 358 and apart of the extended section 456 of the planet gear carrier 455 and a part of the ring gear 457.

FIG. 5 shows a schematic illustration of a section of the shifter 150 from FIG. 4. A part of the extended section 456 of the planet gear carrier, and a part of the ring gear 457, and the switching unit 358 in the shifter 150 are shown therein.

The extended section 456 of the planet gear carrier has a first snap-fit section 556. The ring gear 457 has a second snap-fit section 557. The snap-fit sections are in the form of a snap-fit toothing.

The switching unit 358 has, merely by way of example, an electromagnet 558 and a snap-fit rocker 559 according to the exemplary embodiment of the present invention depicted here. The snap-fit rocker 559 can be moved by the electromagnet 558. In other words, the electromagnet is disposed and designed to move the snap-fit rocker 559. The electromagnet 558 can be activated by the gear selection signal. The snap-fit rocker 559 is designed to snap into the first snap-fit section 556 or the second snap-fit section 557. The switching unit 358 is thus designed to mechanically lock the extended section 456, and thus the planet gear carrier or the ring gear 457, in place in response to the gear selection signal.

It should be noted in particular in reference to FIGS. 3 to 5 that with the implementation of the shifter 150, a structure is used containing the drive unit 351, the switching unit 358, the worm gear 352, the planetary gear assembly 354, the two sliders 356A and 356B, and optionally, the connecting elements, as key components.

It should be noted in reference to FIGS. 1 to 5 regarding the functioning or operation of the gearshift transmission system 190 that the drive unit 351 causes an actuation of both cable pulls, or connecting elements 162 and 164, respectively, in the pulling or pushing direction via the planetary gear assembly 354. The worm gear 352 reduces the rotational rate of the drive unit 351 before a torque is applied to the planetary set 355 or 453, 454, 455 and 456 via the sun gear 452. The output drive 458 can take place selectively via the planet gear carrier 455 or the ring gear 457. Switching between the two outputs is achieved through the switching unit 358 with the electromagnet 559, or switching magnet, which is configured to selectively fix the ring gear 457 or the planet gear carrier 455 in place. The mechanical interfaces 356A, 356B, 357A and 357B are disposed on the output drives, which are configured to convert rotational movement of the ring gear 457 and the planet gear carriers 455 into translational movement. This is achieved through an eccentric 357A and 357B, for example, each of which moves an axially guided slider 356A and 356B respectively. A cable pull or connecting element 162 and 164 respectively, is coupled to each slider 356A and 356B in order to obtain a mechanical connection to the gearshift transmission 140. As with a manual transmission, the cable pull movement is then converted into an actuation of gear selection shafts in the gearshift transmission 140 via a lever. The positions of the sliders 356A and 356B are determined in the shifter 150 by means of the sensors 359A and 359B.

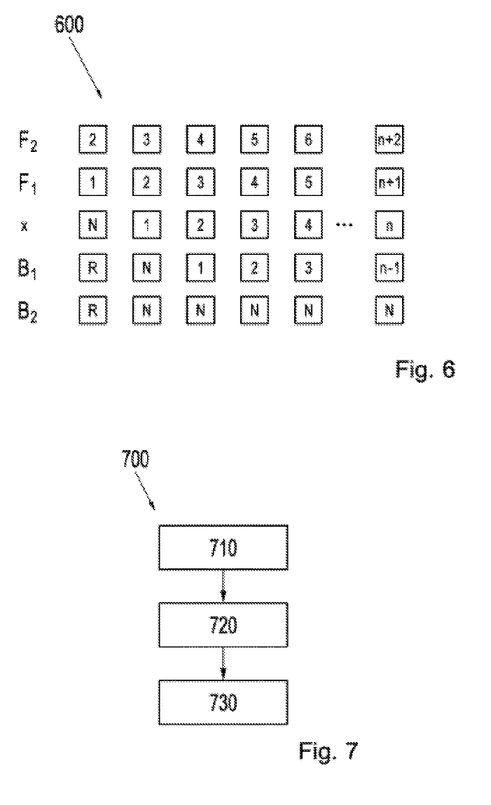

FIG. 6 shows a schematic illustration of a shift pattern 600 according to an exemplary embodiment of the present invention. The shift pattern 600 relates to the gearshift transmission system from FIG. 1 or FIG. 2, or a similar gearshift transmission system. In particular, the shift pattern 600 relates to a circuit with an electrical connection to the transmission, or a so-called shift-by-wire circuit, and in particular to an automated manual transmission (AMT). The shift pattern shown in FIG. 6 can be used for such an AMT, for example.

A first column of the shift pattern 600 shows driving stage positions or shifting state positions F2, F1, x, B1 and B2, which can be selected in the actuation unit or in the gearshift transmission system. A first set of driving stage positions, or gears or shifting states, are listed in a second column of the shift pattern 600, wherein the gears are 2, 1, N, R, and R, corresponding to the sequence of gear selection positions. A second set of gears are listed in a third column of the shift pattern 600, wherein the gears are 3, 2, 1, N and N, corresponding to the sequence of gear selection positions. A third set of gears are listed in a fourth column of the shift pattern 600, wherein the gears are 4, 3, 2, 1 and N, corresponding to the sequence of gear selection positions. A fourth set of gears are listed in a fifth column of the shift pattern 600, wherein the gears are 5, 4, 3, 2 and N, corresponding to the sequence of gear selection positions. A fifth set of gears are listed in a sixth column of the shift pattern 600, wherein the gears are 6, 5, 4, 3 and N, corresponding to the sequence of gear selection positions. A continuation to an imaginary seventh column of the shift pattern 600 symbolized by dots ( . . . ), in which the imaginary gears n+2, n+1, n, n−1 and N are listed.

It is also possible with such a shift pattern 600 to enable an at least partially autonomous operation for a manual transmission. Moreover, this enables a uniform interior design for vehicles, because the operating elements, in particular the actuating unit, can have a uniform and compact design. Different and/or comparable shift patterns can also be used in similar, small installation spaces in accordance with exemplary embodiments.

FIG. 7 shows a flow chart for an installation method 700 according to an exemplary embodiment of the present invention. The installation method 700 is suitable, or can be executed, for installing a shifter for a gearshift transmission of a vehicle. The installation method 700 can be executed to install the shifter from any of the FIG. 1 to 6, or a similar shifter. The installation method 700 can also be executed in conjunction with the gearshift transmission systems from FIG. 1 and FIG. 2.

The installation method 700 has a step 710 for placing the gearshift transmission system shifter, wherein the shifter is located closer to the actuating unit than the gearshift transmission. According to one exemplary embodiment, the method 700 can also contain an upstream step for pre-installation of at least a section of the gearshift transmission system.

According to the exemplary embodiment of the present invention illustrated in FIG. 7, the installation method 700 also contains a step 720, following the placement step 710, for mechanically coupling the shifter to the gearshift transmission by means of the at least one connecting element, and a step 730 for connecting the shifter to the actuating unit for signal transmission. The sequence of the coupling step 720 and the connecting step 730 can be arbitrary.

The exemplary embodiments shown in the figures and described above have been selected merely by way of example. Different exemplary embodiments can be combined with one another, either in their entirety or with regard to individual features. Furthermore, an exemplary embodiment can be supplemented by features of another exemplary embodiment.

Moreover, method steps according to the invention can be repeated or executed in a different sequence than that described herein.

If an exemplary embodiment comprises an “and/or” conjunction between a first feature and a second feature, this can be read to mean that the exemplary embodiment contains both the first feature and the second feature according to one embodiment, and contains either just the first feature or just the second feature according to another embodiment.

### LIST OF REFERENCE SIGNS

100 drive train
110 motor
120 clutch
130 clutch actuator
140 gearshift transmission
150 shifter
162 first connecting element
164 second connecting element
170 actuating unit
175 control signal
182 first electrical interface
184 second electrical interface
190 gearshift transmission system
266 further connecting element
351 drive unit
352 worm gear
354 planetary gear assembly
354 planetary gear assembly
355 planetary set
356A first slider
356B second slider
357A first eccentric
357B second eccentric
358 switching unit
359A first sensor
359B second sensor
362 first movement axis
364 second movement axis
451 drive shaft
452 sun gear
453 first planet gear
454 second planet gear
455 planet gear carrier
456 extended section
457 ring gear
458 output
556 first snap-fit section
557 second snap-fit section
558 electromagnet
559 snap-fit rocker
600 shift pattern
700 installation method
710 placement step
720 coupling step
730 connecting step

1. A shifter for gear selection in a gearshift transmission for a vehicle, wherein the shifter is connectable to an actuating unit for signal transmission to initiate a gear selection by a gear selection signal transmitted to the shifter, wherein the shifter has at least one mechanical interface mechanically coupling the shifter to the gearshift transmission by at least one connecting element, and wherein the shifter is configured to exert a translational movement on the at least one mechanical interface for selecting the gear by the at least one connecting element, as a function of the gear selection signal.

2. The shifter according to claim 1, comprising a drive unit and a planetary gear assembly, wherein the planetary gear assembly is coupled to the drive unit at an input end, and the planetary gear assembly is coupled to the at least one mechanical interface at an output end.

3. The shifter according to claim 2, further comprising a worm gear coupled at the input end to the drive unit and at the output end to the planetary gear assembly, wherein the drive unit is configured as an electric motor.

4. The shifter according to claim 2, wherein the planetary gear assembly includes a sun gear at the input end, and at least one planet gear at the output end, which is disposed on a carrier, and a ring gear, wherein the shifter has a switching unit configured to mechanically lock the carrier or the ring gear in place, depending on the gear selection signal.

5. The shifter according to claim 4, wherein the switching unit has at least one electromagnet and a snap-fit rocker, which can be moved by the electromagnet, wherein the carrier has a first snap-fit section, and the ring gear has a second snap-fit section, wherein the snap-fit rocker is configured to snap into the first snap-fit section or the second snap-fit section.

6. The shifter according to claim 1, wherein the shifter has a first mechanical interface mechanically coupling the shifter to the gearshift transmission by a first connecting element and a second mechanical interface for mechanically coupling the shifter to the gearshift transmission by a second connecting element.

7. The shifter according to claim 1, wherein the at least one mechanical interface includes an eccentric and a slider, which are mechanically coupled to one another, wherein a rotation of the eccentric causes a displacement of the slider, and wherein the slider is configured to be mechanically coupled to a connecting element.

8. The shifter according to claim 1, comprising at least one sensor configured to detect at least one of a position and a pathway of the at least one mechanical interface and an element of the mechanical interface.

9. A gearshift transmission system for a vehicle, the gearshift transmission system comprising:
a shifter according to claim 1;
an actuating unit for initiating the gear selection by the gear selection signal transmitted to the shift, the actuating unit configured to be connected to the shifter for signal transmission, and including a control device for supplying the gear selection signal;
a gearshift transmission; and
at least one first connecting element, by which the gearshift transmission is configured to be mechanically coupled to the shifter.

10. The gearshift transmission system according to claim 9, wherein the shifter is closer to the actuating unit than the gearshift transmission when the gearshift transmission system is installed in the vehicle.

11. The gearshift transmission system according to claim 9, wherein the at least one connecting element is exposed between a housing of the gearshift transmission and the shifter when the gearshift transmission system is installed in the vehicle.

12. A drive train for a vehicle, the drive train comprising:
a gearshift transmission system according to claim 9;
a motor;
a clutch configured to be mechanically interconnected between the motor and the gearshift transmission system; and
a clutch actuator for actuating the clutch, wherein the clutch actuator is configured to be mechanically coupled to the clutch, and the clutch actuator is configured to be connected to the actuating unit of the gearshift transmission system for signal transmission.

13. The drive train according to claim 12, wherein the clutch actuator is configured to be disposed adjacent to the clutch.

14. The drive train according to claim 12, wherein the clutch actuator is configured to be disposed adjacent to a pedal assembly in the vehicle, and the clutch actuator is configured to be mechanically coupled to the clutch via a second connecting element.

15. A method for installing a shifter for a gearshift transmission in a vehicle, the method comprising placing the shifter in the gearshift transmission system according to claim 9 closer to the actuating unit than the gearshift transmission.

16. A shifter for gear selection in a gearshift transmission for a vehicle, the shifter coupled to an actuating unit for signal transmission to initiate a gear selection via a gear selection signal transmitted to the shifter, the shifter comprising at least one connecting element at a mechanical interface to mechanically couple the shifter to the gearshift transmission, the shifter configured to exert a translational movement on the at least one mechanical interface for selecting the gear by the at least one connecting element, as a function of the gear selection signal.

17. The shifter according to claim 16, further comprising:
a drive unit; and
a planetary gear assembly coupled to the drive unit at an input end, the planetary gear assembly coupled to the at least one mechanical interface at an output end.

18. The shifter according to claim 17, further comprising a worm gear coupled at the input end to the drive unit and at the output end to the planetary gear assembly, wherein the drive unit is configured as an electric motor.

19. The shifter according to 17, wherein the planetary gear assembly comprises:
a sun gear at the input end;
at least one planet gear at the output end, the at least one planet gear disposed on a carrier; and
a ring gear, wherein the shifter has a switching unit configured to mechanically lock the carrier or the ring gear in place, depending on the gear selection signal.

20. The shifter according to claim 19, wherein the switching unit has at least one electromagnet and a snap-fit rocker movable by the electromagnet, wherein the carrier has a first snap-fit section, and the ring gear has a second snap-fit section, and the snap-fit rocker is configured to snap into the first snap-fit section or the second snap-fit section.
